(19) United States
(12) Patent Application Publication
(10) Pub. No.: US 2002/0195760 A1
(43) Pub. Date: Dec. 26, 2002

(54) Spring having a high natural frequency and a low spring rate

(75) Inventor: Marold W. Lavy, Oklahoma City, OK (US)

Correspondence Address: COOPER CAMERON CORPORATION, 13013 NORTHWEST FREEWAY, PO BOX 1212 (77251-1212), HOUSTON, TX, 77040, US

(73) Assignee: Cooper Cameron Corporation

(21) Appl. No.: 09/864,586

(22) Filed: May 24, 2001

(51) Int. Cl. F16F 1/06

(52) U.S. Cl. 267/166

(57) ABSTRACT

A compound spring is disclosed that has the benefit of a low preload force and a relatively high natural frequency. In its most basic form it is a helical spring having a cylindrical section and a tapered section. In the preferred embodiment the preload force is linear with increased spring deflection and the spring is unaffected by the harmonics of the surrounding machine. Deflection in the axial direction is a small percentage of the free length. In the preferred embodiment the wire cross-section is constant.

### FIELD OF THE INVENTION

The field of this invention is helical springs and more particularly springs that have multiple sections to give them a desired property of relatively low spring rates and relatively high natural frequencies in comparison to single section helical springs of comparable size.

### BACKGROUND OF THE INVENTION

Helical springs have been in use for a long time for a variety of applications. Such springs have been provided in the past in cylindrical and, separately, in conical form. In each shape such springs have been designed to provide a low spring force coupled with a low natural frequency. Alternatively, each shape has also been used individually to provide a high spring force with a high natural frequency. For each shape various relationships have also been well known and employed in design of such springs. For example, the natural frequency decreased as the number of active coils increases. The natural frequency increases as the wire cross-section increases. The natural frequency decreases with the square of the increase in coil diameter. Another known property of such springs is that if they are put together in series, the spring rate of the composite is less than the spring rate of any of the individual components.

The natural frequency of single section springs could be computed with reasonable accuracy. However if the spring had multiple sections, the natural frequency had to be empirically determined on a shaker table using accelerometers. Some difficulty arises even in the empirical technique as in some instances it is difficult to determine if the accelerometers are measuring axial or lateral vibrations. Theoretical predictions of natural frequencies of combination springs had not been developed.

The present invention arose out of a need to solve a problem for a specific application in an existing design for a rotary screw compressor. Spring failures occurred on both the male and female shafts. It was resolved that the existing springs were being excited by the 3^{rd,} 4^{th,} or 6^{th} harmonic of the cyclic gas thrust load. In trying to solve a problem on an existing machine, there were space constraints if major component redesign was to be eliminated. The preload force of the spring on the shaft radial bearing had to be kept at fairly low levels of about 120 pounds. The desired frequency to avoid harmonics of the thrust load was in the neighborhood of about 3300 Hz or more. The soft spring rate was required to minimize the effect of manufacturing tolerance stack up on the thrust bearing preload. It was also desired to keep the force versus displacement relationship liner in an application involving limited axial displacement. In the preferred solution a constant wire cross-section was desirable to minimize manufacturing costs. Accordingly the main objective of the present invention is to provide a coil spring meeting the low preload with high natural frequency characteristics while being compressed in service minimally as a percentage of its free length.

A variety of known spring designs are illustrated in U.S. Pat. Nos. 4,079,926; 4,017,062; 3,507,486; 4,235,317; 4,957,277 and 4,077,619. The '619 describes a spring for automobile chassis applications where on at least one end a truncoconical portion is designed to have a variable wire diameter and to be squashed flat without contact of an adjacent cylindrical section. The idea is to effectively reduce the diameter of the spring so as to migrate the pressure center closer to the geometric center and minimize torque applied to the support as loading increases. There is no issue of natural frequency adjustment to avoid harmonics from the surrounding machine and the chassis spring becomes a cylindrical spring as, by design, the trunco-conical portion is squashed flat.

The previously stated advantages of the compound spring of the present invention will be more readily understood from a description of the preferred embodiment, which appears below.

### SUMMARY OF THE INVENTION

A compound spring is disclosed that has the benefit of a low preload force and a relatively high natural frequency. In its most basic form it is a helical spring having a cylindrical section and a tapered section. In the preferred embodiment the preload force is linear with increased deflection and the spring is unaffected by the harmonics of the surrounding machine. Deflection in the axial direction is a small percentage of the free length. In the preferred embodiment the wire cross-section is constant.

### BRIEF DESCRIPTION OF THE DRAWINGS

FIG. 1 is a section view of a rotary screw compressor showing the location of cylindrical springs, for bearing preload in a rotary screw compressor application;

FIG. 2 is a section view of a two section spring of the present invention;

FIG. 3 is a section view of a three section spring of the present invention. FIG. 4 is the view of FIG. 1 with compound springs installed.

### DETAILED DESCRIPTION OF THE PREFERRED EMBODIMENT

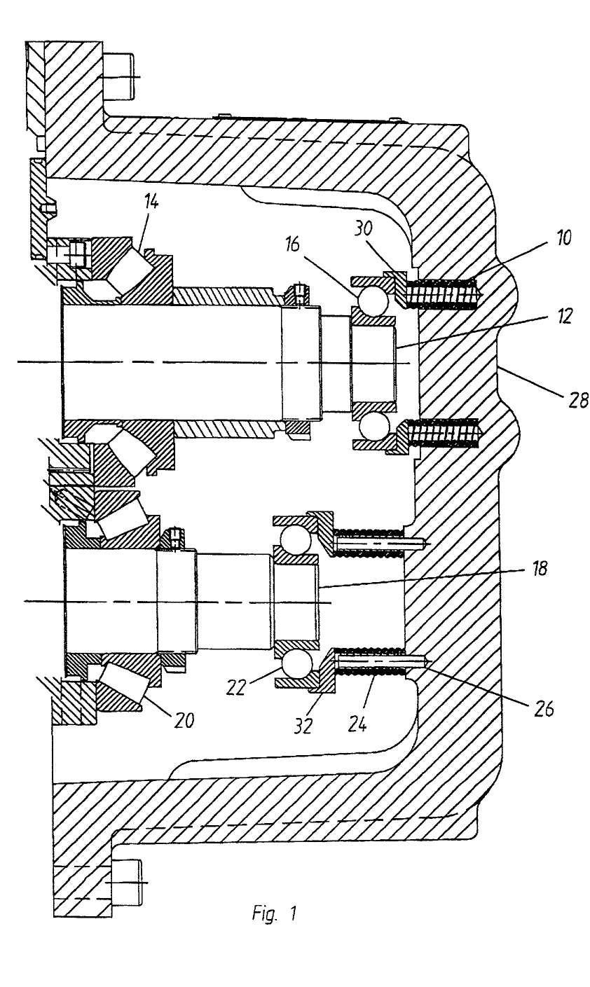

Referring to FIG. 1, the placement of spring 10 is shown for a rotary screw compressor. A male shaft 12 has a thrust bearing 14 and a radial bearing 16 at one end.

Similarly, the meshing female shaft 18 has a thrust bearing 20 and a radial bearing 22 at one of its ends. In FIG. 1 the spring 10 puts a preload on the bearings of the male shaft 12 while another spring 24 is the counterpart on the female shaft 18. Optionally a spring pin 26 may be used to guide the movements of spring 24. The housing 28 can also be used to guide, as shown for spring 10. A support, such as 30 or 32 can be used to distribute the load from springs 10 and 24 to their respective shafts. Springs 10 and 24 originally were cylindrical with a natural frequency of about 984 Hz. It was determined that these springs failed due to resonation from the surrounding equipment. It was later determined that for reliable operation the requirements for the springs 10 or 24 should have been that the bearing preload force be small in the order of about 120 pounds and the natural frequency be high, in the order or in excess of 3300 Hz. The springs 10 and 24 were the original design for the existing machine and were cylindrically shaped. They met the low preload requirement but the natural frequency was too low.

The original springs had the required low preload force but also had a sufficiently low natural frequency in the order of 984 Hz so as to be harmonically excited by the thrust load during normal operation of the compressor involving rotor speeds at a range of 1800-4800 RPM.

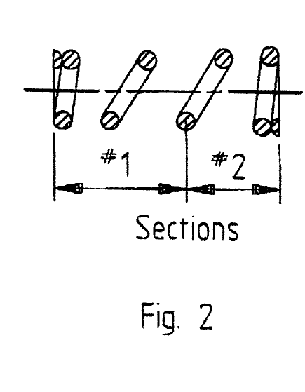

The preferred embodiment of the replacement for springs 10 and 24 is illustrated in FIG. 2. This spring 34 is made from a constant wire cross-section having a diameter of 0.120 inches. It has 4.5 coils and 2.5 of them are active coils. It has a pitch of 0.521 inches and a spring force at 0.086 inches of deflection of 113 pounds. Its ends are squared and ground. It has two sections, labeled on the drawing as #1 and #2. Section 1 is cylindrical and section 2 is tapered. The cylindrical section has an outside diameter of 0.535 inches and the large end of the tapered section has an outside diameter of 0.605 inches. Section 1 has 1.5 active coils while section 2 has 1 active coil. On a shaker table measured values of the natural frequency were measured in the range of 3900-4300 Hz, which ranged within 7-19% of the computed natural frequency by the method described below. This compared to a frequency of 984 Hz for the original cylindrical springs 10 and 24.

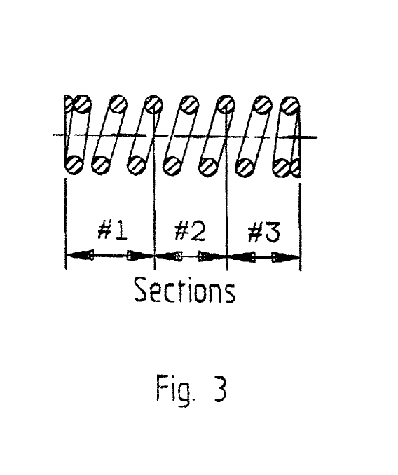

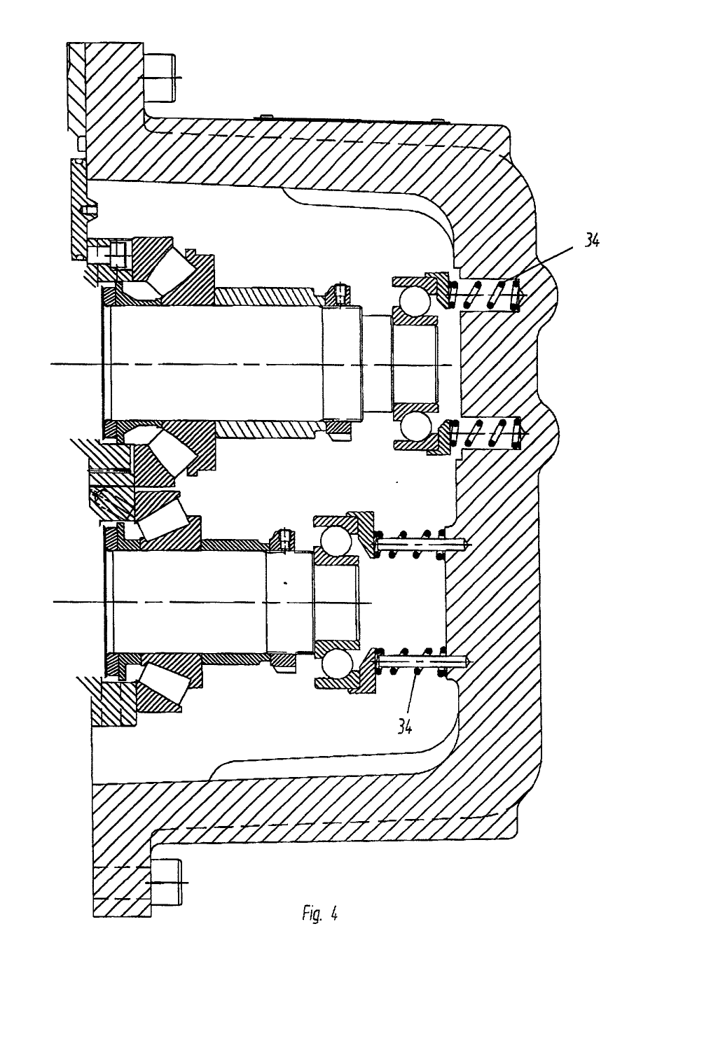

Another embodiment is shown in FIG. 3. This spring is somewhat longer than the version shown in FIG. 2, 1.61 inches versus 1.542 inches. It has a pitch of 0.249 inches and uses the same constant wire diameter of 0.120 inches. There are 7.5 active coils of which 5.5 are active. Section 1 has 2 active coils in a cylindrical section having an outside diameter of 0.535 inches. Section 2 is tapered and grows to 0.550 inches over 2 active coils. Section 3 is cylindrical having an outside diameter of 0.550 inches over 1.5 active coils. On a shaker table, this spring yielded natural frequencies in the range of 1250-1650 Hz, which correlated closely with the theoretical calculations, illustrated below for compound springs.

In both instances the preferred material was ASTM A401 chrome-silcon. In the case of spring 34 shown in FIG. 2, when installed in the compressor, as shown in FIG. 4, the amount of deflection compared to the free length was minimal, in the order of 6%. It would be undesirable to fully compress any of the active coils in spring 34, shown installed in FIG. 4. In essence spring 34 is a static as opposed to a dynamic spring in that the amount of deflection after installation is in the order of a few thousands of an inch. The active coils never touch each other. It has a linear force versus displacement relationship. Spring 34 presents a solution to a specific vibration problem.

In its broad sense, the present invention relates to compound helical springs having at least two sections where one is cylindrical and another is tapered which in operation not only exhibits a linear force/displacement relationship but also and minimally provides low preload force while providing a high natural frequency to avoid resonance due to the operating frequency of the machine in which it resides. As previously stated, cylindrical springs can provide the desirable low preload force but only at the expense of having a low natural frequency. This was a condition of cylindrical springs 10 and 24, which made them unsuitable because of resonation, which lead to early failure. In order to get a high natural frequency out of a cylindrical spring the price is that it will also have a large preload force. The present invention derives from the realization that if springs are put in series the effective spring rate of the combination of springs is less than the spring rate of any of the individual springs. A compound spring comprising at least one cylindrical and at least one tapered section results in a low linear spring rate but an increased natural frequency. It was this discovery, which was empirically confirmed that forms the invention. Subsequently, Professor Charles Bert of Oklahoma University has confirmed a theoretical verification of this phenomenon, as indicated below.

The solutions for the free axial vibration of prismatic or tapered bars are well known. However, any previous analyses of the free vibration of compound bars, i.e., bars arranged in mechanical series are unknown. The objective of the present investigation is to solve this problem exactly, to present several simple approximate equations for estimating the fundamental frequency, and to apply these results to helical springs.

### Exact Solution

The subject system is a compound bar consisting of an arbitrary number (n) of prismatic segments. The governing differential equations of motion are

aᵢ²u_{i,xx}=u_{i,u}; i=1, . . . n (1)

where a, is the acoustic wave velocity of a typical segment i, uᵢ=uᵢ(x, t) is the axial displacement of bar i at position x and time t, and ( ),ₓₓ denotes ∂²( )/∂x², etc.

The general solutions of Eqs. (1) are

uᵢ(x,t)=Uᵢ(x)cos ωt (2)

where Uᵢ (x) is the mode shape of segment i, and ω is the circular natural frequency. The general solutions for the mode shapes are

Uᵢ(x)=αᵢ cos(ωx/aᵢ)+βᵢ sin (ωx/aᵢ) (3)

Taking the origin of the coordinate system to be at the left end of segment 1, letting Lᵢ be the length of segment i, and considering the compound bar to be fixed at both ends (for instance), the boundary and junction conditions can be expressed as

$$\begin{matrix}{U}_{1} ( 0 ) = 0 \\ {U}_{i} ( Σ {L}_{i} ) = {U}_{i + 1} ( Σ {L}_{i} ) \\ {A}_{i} {E}_{i} {U}_{i , x} ( Σ {L}_{i} ) = {A}_{i + 1} {E}_{i + 1} {U}_{i + 1 , x} ( Σ {L}_{i} ) \\ ⋮ \\ {U}_{n} ( Σ {L}_{n} ) = 0\end{matrix} \qquad ( 4 )$$

where

$$Σ {L}_{i} = {\sum }_{j = 1}^{i} {L}_{j} .$$

For the example of a two-segment bar, Eqs. (4) reduce to

U₁(0)=0; U₁(L₁)=U₂(L₁);

A₁E₁U_{1,x}(L₁)=A₂E₂U₂U_{2,x}(L₁); U₂(L₁+L₂)=0 (4a)

Substitution of Eqs. (3) into Eqs. (4) leads to a set of 2n homogeneous algebraic equations in the coefficients αᵢ and βᵢ (i=1, . . . n). The determinant of this set must be forced to vanish in order to guarantee a nontrivial solution. This frequency determinant is transcendental in the frequency ω, because the coefficients are of the form of both sine and cosine functions. For a two-segment bar (n=2), for instance, the frequency equation consists of two terms containing sines and cosines to the second degree:

(A₁E₁/a₁)cos(ωL₁/a₁)sin(ωL₂/a₂)+(A₂E₂/a₂)sin(ωL₁/a₁)cos(ωL₂/a₂)=0 (5a)

For a three-segment bar, the frequency equation consists of sixteen terms containing sines and cosines to the fifth degree.

### Approximate Formulas for the Fundamental Natural Frequency

Due to the complexity of obtaining an exact solution and the need for designers to have relatively simple algebraic formulas, two such formulas are proposed here for the fundamental natural frequency of an n-segment compound bar.

The first formula was motivated by the famous Dunkerley's formula (Dunkerley, 1895) but its exact form was suggested by the actual exact solutions for the case of n=2:

$$ω = {[ {\sum }_{i = 1}^{n} ( 1 / {ω}_{i} ) ]}^{- 1} \qquad ( 6 )$$

where ωᵢ is the fundamental natural frequency of segment i. This is different than Dunkerley's formula, which is

$$ω = {[ {\sum }_{i = 1}^{n} {( 1 / {ω}_{i} )}^{2} ]}^{- \frac{1}{2}} \qquad ( 7 )$$

The second formula was motivated by the effective static stiffness of an n-segment spring:

$$K = {[ {\sum }_{i = 1}^{n} ( 1 / {k}_{i} ) ]}^{- 1} \qquad ( 8 )$$

and the total mass of the system

$$M = {\sum }_{i = 1}^{n} {m}_{i} \qquad ( 9 )$$

Then

ω=π(K/M)^{1/2} (10)

It is noted that for a bar,

kᵢ=AᵢEᵢ/Lᵢ

### Numerical Results

As a first step toward evaluating the two approximate formulas, the case of a two-segment bar with k₂=1, L₁=L₂=1, and m₁=m₂=1 is considered for various values of the ratio k₁/k₂. The results are tabulated as follows:

TABLE 1
Values of ω/ω₁

| k₁/k₂ | Exact | Eq. (6) | % error | Eq. (10) | % error |
|---|---|---|---|---|---|
| 0.25 | 0.7323 | 0.6667 | −6.6 | 0.6325 | −13.6 |
| 0.49 | 0.6062 | 0.5882 | −3.0 | 0.5793 | −4.4 |
| 0.50 | 0.6028 | 0.5858 | −2.8 | 0.5774 | +4.2 |
| 0.98 | 0.5023 | 0.5025 | +0.04 | 0.5025 | +0.04 |
| 1.00 | 0.5000 | 0.5000 | 0 | 0.5000 | 0 |
| 1.02 | 0.4975 | 0.4975 | 0 | 0.4975 | 0 |
| 4.00 | 0.3662 | 0.3333 | −9.0 | 0.3162 | −13.7 |
| 9.00 | 0.2902 | 0.2500 | −13.0 | 0.2236 | −22.9 |

It is noted that neither Eq. (6) nor Eq. (10) gives an upper or lower bound, but Eq. (6) is always as good as or better than Eq. (10).

The fundamental frequency of a single cylindrical helical spring is given by

ω=π(k/m)^{1/2}

where k is the spring rate and m is the active-coil mass (Wahl, 1963). Thus, the present analysis can readily be applied to compound springs.

### Reference

Dunkerley, S., 1894, “On the whirling and vibration of shafts”, Philosophical Transactions of the Royal Society, London, Ser. A, Vol. 185, pp. 279-360.

Wahl, A. M., 1963, Mechanical Springs, 2^{nd} ed., McGraw-Hill, New York, chapter 25.

Those skilled in the art will appreciate that by selecting the right number of elements and the proper geometry for each element, a compound spring can be designed to solve two problems that cannot be solved by use of a either a cylindrical or a conical spring standing alone. Applications requiring low preloads and high natural frequencies can be addressed with a compound spring of the present invention. Natural frequencies, in one example can exceed 3000 Hz with preload forces below 120 pounds. Other combinations are obtainable such as FIG. 3 if lower frequencies are desired. The natural frequency can also be modified upwardly by increasing the wire cross-section or decreasing the coil diameter. On retrofit situations the space available may dictate how much each variable can be modified. In particular, in a retrofit situation where the length and diameter cannot be significantly varied, increases in the natural frequency of three fold and higher can be obtained without a significant increase in preload force. In new designs a ratio of natural frequency in Hz to preload force in pounds in excess of 10:1 are attainable, as shown in the 3 section spring of FIG. 3. Ratios of about 30:1 or more are possible as shown in the two section retrofit design of FIG. 2. It should also be noted that a coil fragment for a transition piece can join two cylindrical sections of differing coil diameters and the behavior of that assembly will be akin the spring shown in FIG. 3. Alternatively, two tapered sections having one common small coil diameter can be joined to make a two-section spring with the desired high natural frequency and low preload force. Alternatively, the two tapers of different angles can be aligned in the same direction with a transition piece in between. The transition piece will function akin to a tapered section between the other two tapered sections to get the desired results.

While the invention has been described and illustrated in detail in the drawings and foregoing description, the same is to be considered as illustrative and not restrictive in character, it being understood that only the preferred embodiment has been shown and described and that all changes and modifications that come within the scope of the claims below are the full scope of the invention being protected.

I claim:

1. A coiled helical spring, comprising:
at least one cylindrical section and at least one other non-cylindrical section of active coils such that the natural frequency of the combined sections is sufficiently high so as to not resonate from vibration from structures in contact with it

2. The spring of claim 1, wherein:
said non-cylindrical section is tapered

3. The spring of claim 2, wherein:
said cylindrical and tapered sections are connected by continuous winding, in series.

4. The spring of claim 3, wherein:
said tapered section has a largest coil diameter, which exceeds the coil diameter of said cylindrical section.

5. The spring of claim 1, further comprising:
at least two cylindrical sections having a tapered non-cylindrical section between them.

6. The spring of claim 1, wherein:
the relationship of spring force to displacement is only linear.

7. The spring of claim 1, wherein:
the cross-section of the spring is constant throughout its length.

8. The spring of claim 1, wherein:
said non-cylindrical section is sufficiently close in outer dimension to said cylindrical section so as to preclude nesting of said sections upon sufficient compression.

9. The spring of claim 1, wherein:
the ratio of the natural frequency in Hz to the preload force applied in pounds is in excess of 10:1.

10. The spring of claim 9, wherein:
the ratio of the natural frequency in Hz to the preload force applied in pounds is in excess of 30:1.

11. A coiled helical spring, comprising:
at least two cylindrical sections of differing coil diameters of active coils joined by a transition segment such that the natural frequency of the combined sections is sufficiently high so as to not resonate from vibration from structures in contact with it.

12. The spring of claim 11, wherein:
said transition segment functions as a tapered segment.

13. A coiled helical spring, comprising:
at least two tapered sections of active coils of different taper angles joined to each other such that the natural frequency of the combined sections is sufficiently high so as to not resonate from vibration from structures in contact with it.

14. The spring of claim 13, wherein:
said tapered sections are connected directly end to end at their smallest coil diameter.

15. The spring of claim 13, wherein:
said tapers are aligned in the same direction and a transition segment connects said at least two tapered sections together.

16. The spring of claim 15, wherein:
said transition segment functions as a tapered segment.

17. The spring of claim 3, wherein:
the smallest coil diameter of said tapered section is less than the coil diameter of said cylindrical section.
